(19) United States
(12) Patent Application Publication
(10) Pub. No.: US 2023/0201635 A1
(43) Pub. Date: Jun. 29, 2023

(54) RESPIRATOR MASK

(71) Applicant: Eurofilters Holding N.V., Overpelt (BE)

(72) Inventors: Ralf Sauer, Overpelt (BE); Jan Schultink, Overpelt (BE)

(73) Assignee: Eurofilters Holding N.V., Overpelt (BE)

(21) Appl. No.: 17/927,113

(22) PCT Filed: Apr. 16, 2021
(86) PCT No.: PCT/EP2021/059969

§ 371 Date: Nov. 22, 2022

(30) Foreign Application Priority Data
May 28, 2020 (EP) 20177108.6

(51) Int. Cl. A62B 23/02; A62B 18/08; A41D 13/11; B01D 39/16

(52) U.S. Cl. CPC A62B 23/025; A62B 18/084; A41D 13/11; B01D 39/1623; B01D 2239/0283; B01D 2239/0654; B01D 2239/0618; B01D 2239/0435; B01D 2239/0627; B01D 2239/0233; B01D 2239/0622

(57) ABSTRACT

The invention provides a respirator mask comprising a filter material piece made of an air-permeable material and at least one securing band, wherein the air-permeable material comprises at least one layer of a non-woven fabric comprising or consisting of fibres formed from one or more recycled plastic materials, and wherein the at least one securing band is designed for securing the respirator mask to the head.

The invention relates to a respirator mask.

Respirator masks consistently cover the wearer's mouth and nose with a filter material and are used to protect them from airborne pollutants and to protect the environment from exhaled bacteria and viruses. In this regard, the term includes, among others, in particular a surgical mask, medical face masks and filtering half masks.

The filter material used nowadays generally consists of a non-woven fabric made of plastic material. Many respirator masks are intended for single use and are disposed of afterwards.

Given the ever-increasing demand for respirator masks, this results in a large amount of waste consisting of plastic material.

In view of this, the object underlying the invention is to provide an ecologically improved respirator mask with good filtering and protection properties.

This object is achieved by a respirator mask according to claim 1.

The invention relates to a respirator mask comprising a filter material piece made of an air-permeable material and at least one securing band,
wherein the air-permeable material comprises or consists of at least one layer of a non-woven fabric of fibres formed from one or more recycled plastic materials, and
wherein the at least one securing band is designed to secure the respirator mask to the head.

The term “recycled plastic material” used for the purposes of the present invention is to be understood as synonymous with plastic material recyclates. A recycled plastic material or plastic material recyclate is obtained from the recycling of production, processing (pre-consumer) or post-consumer waste. The processing into recyclate typically takes the form of regrind, re-processed material, regenerates or compounds, agglomerates or compacted material. The recyclate produced is used again in the processing of plastic material products. Recycled plastic material is therefore a secondary raw material. Concerning the characterisation of plastic material waste, reference is made to the standard DIN EN 15347:2007.

The filter part of the respirator mask in the form of the filter material piece is accordingly made of an air-permeable material that may have a construction with one or more layers. At least one of these layers is a non-woven fabric that comprises recycled plastic materials and, in particular, is formed from recycled plastic materials.

In contrast to the respirator masks known from the prior art, less or no fresh/pure (virgin) plastic material (primary material) is used for the production of the non-woven fabrics on which the filter material piece of the respirator mask is based; instead, mainly or exclusively plastic materials are used that have already been in use and have been recovered by appropriate recycling processes (secondary material). Such respirator masks are clearly advantageous from an ecological point of view, as they may be manufactured in a highly neutral way regarding the raw material.

For the purposes of the present invention, a “non-woven fabric” means an entangled mesh which has undergone a bonding step (non-woven bonding step) so that it has sufficient strength to be wound into rolls or unwound from these, in particular by machine (i.e. on an industrial scale). The minimum web tension required for such a winding into rolls is 0.044 N/mm. The web tension should not be higher than 10% to 25% of the minimum maximum tensile force (according to DIN EN 29073-3:1992-08) of the material to be wound. This results in a minimum maximum tensile force for a material to be wound of 8.8 N per 5 cm strip width.

A “fibre web” (or just “web”) corresponds to an entangled mesh, which, however, has not undergone a bonding step, so that, in contrast to a non-woven fabric, such an entangled mesh does not have sufficient strength to be wound into rolls or unwound from these by machine, for example.

The term “non-woven fabric” is used in other words as defined in ISO standard ISO 9092:1988 or CEN standard EN 29092. Details on the use of the definitions and/or processes described therein may also be found in the textbook “Vliesstoffe”, H. Fuchs, W. Albrecht, WILEY-VCH, 2012.

“Fibres” refers to both fibres of finite length (e.g. staple fibres) and fibres of theoretically infinite length, i.e. continuous fibres or filaments.

In one embodiment, the fibres of one or more non-woven fabrics included in the air-permeable material of the filter material piece or filter part of the respirator mask are formed from a single recycled plastic material.

Alternatively, it is however also possible that the fibres of one or more non-woven fabrics are formed from different materials, at least one of which is a recycled plastic material. Two embodiments in particular are conceivable here:

On the one hand, it may be a mixture of at least two types of fibres, for example fibre mixtures formed from at least two different recycled plastic materials.

On the other hand, it is also possible that the non-woven fabric includes or is formed from bicomponent fibres (bico fibres). These may consist of a core and a shell surrounding the core. Core and shell are made of different materials. In addition to core/shell bicomponent fibres, the other common variants of bicomponent fibres (e.g. side by side) may also be considered.

The bicomponent fibres may be staple fibres or be configured as an extrusion non-woven fabric (for example as meltblown, spunbond or spun-blown non-woven fabric), the bicomponent fibres theoretically having infinite length and building so-called filaments. In the case of such bicomponent fibres, it is an advantage if at least the core is made of a recycled plastic material; a virgin plastic material, but alternatively another recycled plastic material, may also be used for the shell for example.

Bicomponent fibres whose core consists of recycled polyethylene terephthalate (rPET) or recycled polypropylene (rPP), the shell consisting of polypropylene, which may be a virgin or a recycled material, are particularly advantageous.

In particular, when the bicomponent fibres are used as binder fibres, both core and shell may be made of recycled plastic materials. When the bicomponent fibres are meltblown, the shell consists preferably of virgin material to be reliably persistently chargeable.

As non-woven fabrics for the purposes of the present invention dry-laid, wet-laid or extrusion non-woven fabrics may be used. Thus the fibres of the non-woven fabrics may be of finite length (staple fibres), but also theoretically of infinite length (filaments).

The respirator mask may in particular consist of the filter material piece and the at least one securing band. The securing band may be welded or glued to the filter material piece. According to an alternative, the securing band may also be coupled to the filter material piece by interlocking, for example by means of a rivet.

The filter material piece forms the filter part of the respirator mask, providing the filtering of the inhaled and exhaled air.

The recycled plastic material may be selected from the group consisting of recycled polyesters, in particular recycled polyethylene terephthalate (rPET), recycled polybutylene terephthalate (rPBT), recycled polylactic acid (rPLA), recycled polyglycolide and/or recycled polycaprolactone; recycled polyolefins, in particular recycled polypropylene (rPP), recycled polyethylene and/or recycled polystyrene (rPS); recycled polyvinyl chloride (rPVC), recycled polyamides and mixtures and combinations thereof.

There are relevant international standards for many plastic material recyclates. For PET plastic material recyclates, for example, DIN EN 15353:2007 is relevant. PS recyclates are described in more detail in DIN EN 15342:2008. PE recyclates are dealt with in DIN EN 15344:2008. PP recyclates are characterised in DIN EN 15345:2008. PVC recyclates are described in more detail in DIN EN 15346:2015. For the purpose of the corresponding special plastic material recyclates, the present patent application adopts the definitions of these international standards. The plastic material recyclates may be obtained from metallised or non-metallised raw materials. One example of non-metallised raw materials are plastic material flakes or chips recovered from PET beverage bottles. Likewise, the raw materials may be metallised, e.g. if they have been obtained from metallic plastic material films, in particular metallised PET films (MPET).

The recycled plastic material is in particular recycled polyethylene terephthalate (rPET), obtained for example from beverage bottles, in particular from so-called bottle flakes, i.e. pieces of ground beverage bottles.

The recycled plastic materials, in particular the recycled PET, in both the metallised and non-metallised version, may be spun into the appropriate fibres from which the corresponding staple fibres or meltblown or spunbond non-woven fabrics may be produced for the purposes of the present invention.

In one variant, the air-permeable material may have a single-layer structure, i.e. be composed of exactly one layer of a non-woven fabric as described, i.e. consist of this layer. The non-woven fabric may be spun-blown, in particular made of bicomponent fibres. As described above, the core may be formed from a recycled plastic material, and a virgin/primary plastic material may be used for the shell, for example. The non-woven fabric may be calendered. This increases the strength.

A spun-blown non-woven fabric may be electrostatically charged (e.g. by corona charging or hydro charging).

In another variant, the air-permeable material may be multi-layered, wherein at least one, more or all of the layers comprise or are formed from a non-woven fabric, wherein the non-woven fabric comprises or is formed from fibres comprising or being formed from one or more recycled plastic materials. A specific choice of the individual non-woven fabric and its parameters enables adjusting the filtering properties of the respirator mask in a controlled manner.

In the case of a multi-layer structure, the layers may be welded together along their edges.

The present invention covers several particularly preferred ways of designing the air-permeable material with multiple layers, which are presented below. The plurality of these layers may be joined together by means of welded joints. The layers may also be glued together.

The filter part or the filter material piece of the (finished but unused) respirator mask may have (in top view) a polygonal, in particular substantially rectangular shape. This also applies in particular to the case of a filter material piece with folds. The filter part or the filter material piece may have a three-dimensional shape, for example caused by spatial reshaping. The latter in particular allows a more precise fit to the face shape, resulting in a lower leakage volume flow.

According to one embodiment, the air-permeable material comprises at least one support layer and at least one fine filter layer, wherein at least one or all of the support layers comprise or are formed from recycled plastic materials and/or at least one or all of the fine filter layers are non-woven fabrics comprising or formed from one or more recycled plastic materials.

In particular, the fine filter layer enables the desired protection and filtering function of the respirator mask.

A multi-layer air-permeable material may have a meltblown layer between two support or carrier layers. The meltblown layer, which is the fine filter layer, enables a high filter performance. The meltblown layer may be electrostatically charged (e.g. by corona charging or hydro charging).

One or both carrier layers may be a non-woven fabric, in particular spunbonded or spun-blown. Alternatively, one or both carrier layers may be a mesh (netting). The mesh may have characteristics as described in EP 2 011 556 A1, which is hereby incorporated by reference.

A support layer (sometimes also called “carrier layer” or “reinforcing layer”) within the meaning of the present invention is a layer which provides the necessary mechanical strength to the multi-layer composite of the filter material piece. This refers to an open, porous non-woven fabric or a non-woven fabric with a light weight per unit area. One of the purposes of a support layer is to support other layers. The support layer, as well as any other layer of the filter material, may also be electrostatically charged, provided that the material has suitable dielectric properties.

A fine filter layer serves to increase the filtration performance of the multi-layer filter material piece by trapping particles that pass through the support layer, for example. To further increase the separation efficiency, the fine filter layer may preferably be electrostatically charged (e.g. by corona discharge or hydro charging).

Each support layer of the respirator masks may be a spunbonded non-woven, preferably with a grammage between 5 and 80 g/m², more preferably between 10 and 50 g/m², more preferably between 15 and 30 g/m² and/or preferably with a titre of the filaments forming the spun-bonded non-woven in the range of 0.5 to 15 dtex.

The air-permeable material may preferably comprise one to three support layers.

When two support layers exist, the total grammage of the sum of all support layers is preferably 10 to 200 g/m², more preferably 15 to 150 g/m², more preferably 20 to 100 g/m², more preferably 30 to 90 g/m², in particular 40 to 70 g/m².

It is particularly preferred that all support layers are formed from one or more recycled plastic materials, in particular rPET or rPP.

According to a further advantageous embodiment , each fine filter layer is an extruded non-woven fabric, in particular a meltblown non-woven fabric, preferably with a grammage of 10 to 80 g/m², more preferably 15 to 50 g/m², in particular 20 to 40 g/m².

The air-permeable material may comprise 1 to 5 fine filter layers.

When at least two fine filter layers exist, the total grammage of the sum of all fine filter layers is preferably 10 to 80 g/m², more preferably 15 to 50 g/m², in particular 20 to 40 g/m².

It is particularly preferred that at least one, preferably all, fine filter layers comprise or are formed from one or more recycled plastic material, in particular comprising an rPP. In this case, the at least one fine filter layer may be a bicomponent meltblown non-woven, wherein the core of the bicomponent fibres is formed from an rPP.

To increase the filtration performance, at least one, preferably all, fine filter layers may be electrostatically charged.

One embodiment of the structure of the air-permeable material for the respirator mask according to the invention provides a multi-layer structure with a layer sequence described below:
a support layer, one or two fine filter layers and a further support layer.

In particular, if the support layer is constructed as a spunbonded non-woven fabric and the fine filter layer as a meltblown non-woven fabric, a SMS or SMMS structure is used.

At least one of the layers comprises at least one recycled plastic material, in particular rPET or rPP. Particularly preferably, at least all support layers are made of recycled plastic materials.

The air-permeable material of the respirator mask may comprise a meltblown layer made of bicomponent fibres having a core/shell construction, the core being formed of rPP and the shell being formed of virgin PP. In particular, the core portion may constitute at least 60%, at least 80% or at least 90% of the bicomponent fibres. This allows a high recycled content with good electrostatic chargeability, the latter resulting in particular from the use of virgin PP for the shell.

In the respirator masks described, the at least one securing band may comprise a recycled plastic material or be formed from one or more recycled plastic materials. This allows a further increase in the recycled content of the entire respirator mask.

The at least one securing band may comprise or consist of a layer of a film and/or a layer of a non-woven fabric, for example a meltblown fabric. The non-woven fabric and/or the laminate of the two layers may be a creped material (e.g. obtained by the Micrex/microcreper process). Alternatively or additionally, Vistamaxx (manufacturer: ExxonMobil Chemical) may be used as a material for the non-woven fabric.

The at least one securing band may have a multi-layer structure, wherein the securing band comprises or consists of a layer of a film and a layer of a non-woven fabric, in particular a meltblown fabric.

In the case of a securing band in the form of a laminate comprising a film and a non-woven fabric, the film, in particular in the form of a cast film, may be laminated directly onto the non-woven fabric. Thus no additional adhesive is required.

The at least one securing band may comprise or be formed from a thermoplastic polymer, in particular a recycled thermoplastic polymer. The thermoplastic polymer may in particular be a thermoplastic elastomer. It may be, for example, a thermoplastic polyurethane (TPU) or Vistamaxx. Thus the securing band may be in the form of a laminate of a TPU film and a TPU meltblown, TPU spunbonded or TPU spun-blown material. This construction results in good elasticity with a high stability of the securing band. Furthermore, such a securing band may be advantageously welded to the filter material piece.

The securing band may be configured as a torsade or twisted cord. This increases the wearing comfort. In this case, it is possible to prevent the twist from twisting back again by thermal fusing (e.g. ultrasonic welding).

The respirator masks described may comprise (exactly) two securing bands.

One or more securing bands may be designed to be guided around the back of the head of a wearer (user). Alternatively, one or more securing bands may be designed to be guided around a wearer's (user's) ear.

The at least one securing band may be designed as a closed strap. This means that the corresponding securing band has no loose or open end. This may be achieved, for example, by coupling both ends of a securing band to the filter part or the filter material piece. Alternatively, for example, the corresponding strap may be configured as a closed strap as such; it may therefore have a ring or loop shape.

According to an alternative, the respirator mask may have at least two, in particular four, securing bands with open or loose ends. This means that (only) one end of each securing band is attached to the filter part or a non-woven web. The open/loose ends of two securing bands each may be knotted.

The at least one securing band may extend over an entire length of the filter material piece or filter part. This allows that the at least one securing band runs with the air-permeable material during production and is cut together with the material (at the ends of the filter material piece).

In particular, two securing bands may be provided which extend over an entire length of the filter material piece or filter part. Preferably, these two securing bands are arranged on the same side of the air-permeable material or filter material piece and along two opposite edges of the filter material piece.

The at least one securing band may be coupled, in particular welded, to the air-permeable material at its two end regions.

The previously described respirator masks may include a bendable nosepiece. This allows to optimize the fit, in particular to enhance the sealing of the respirator mask in the eye and nose area, as well as to improve the retention.

In this case, the respirator mask may consist of the air-permeable material, the at least one securing band and the nosepiece.

The nosepiece may be in a arrangement parallel to the non-welded edge. It may be placed on the outside of the respirator mask or embedded in one of the two non-woven webs.

The nosepiece may comprise a single or a double wire. The single or double wire may be embedded in a strip of plastic material or paper-based material.

The nosepiece may be made of aluminium or of PP or PE without wire insert. The plastic material may be formed from a recycled plastic material. The width of the nosepiece may be 1 to 10 mm.

The length of the nosepiece may be 2 to 25 cm, in particular more than 4 cm and/or less than 10 cm. The nosepiece may also extend along the entire length of one edge of the filter material piece. This allows a simplified production, as the nosepiece may be cut together with the filter material piece during the production.

The nosepiece may be attached to the filter material piece in a destructively detachable or non-destructively detachable manner. The nosepiece may be glued or welded to the filter material piece. The fastening by means of adhesive may be done by a hot-melt adhesive. The nose-piece may be coupled to the filter material piece continuously along its entire length or only at individual discrete points.

The respirator masks described above may be configured as half masks. In use, they cover thus the wearer's nose, mouth and chin. The respirator masks described above may be configured as medical face masks according to DIN EN 14683:2019+AC:2019 or as filtering half masks according to DIN EN 149.

The part by weight of all recycled materials relative to the total weight of the respirator mask may be at least 60%, in particular at least 70%, in particular at least 80%, in particular at least 90%, in particular 95%.

The air-permeable material of the respirator mask may be creped. The Micrex/microcreper process in particular may be used for this. Merely by way of example, reference is made to WO 2007/079502. The resulting increase in surface area not only causes a softer appearance; the filter material piece also adapts better to the shape of the face and the moisture absorption of this is enhanced.

The invention also provides a respirator mask comprising a filter material piece made of an air-permeable material and at least one securing band,
wherein the air-permeable material comprises at least one layer of a non-woven fabric and/or a layer of a fibre web and the air-permeable material is creped, and
wherein the at least one securing band is designed to secure the respirator mask to the head.

The creped air-permeable material results in an improved respirator mask regardless of the use of recycled plastic materials. For this respirator mask, the characteristics, parameters and properties described above are also applicable without the recycled plastic materials.

The securing band of the respirator masks described above may be creped. The Micrex/microcreper process in particular may be used also in this case.

A creped securing band allows an advantageous flexibility enabling an adaptation to different head diameters.

Further, the invention provides a protective garment made of an air-permeable material, wherein the air-permeable material comprises at least one layer of a non-woven fabric comprising or consisting of fibres formed from one or more recycled plastic materials.

The protective garment may be, for example, a protective bonnet, a protective cover for shoes, a protective cape or a protective overall.

The air-permeable material of the protective garment may also have the characteristics, parameters and properties described above.

Further the present invention relates to the use of a recycled plastic material, in particular the recycled plastic materials described above, for example in the form of non-woven fabrics for a respirator mask or a protective garment, in particular the production of a respirator mask or a protective garment. Regarding the recycled plastic materials that may be used for this purpose or the possible design of the non-woven fabrics, reference is made in this respect to the preceding explanations.

The present invention will be elucidated in more detail by means of the following exemplary embodiments with reference to the figures, without limiting the invention to the specific embodiments shown. In which:

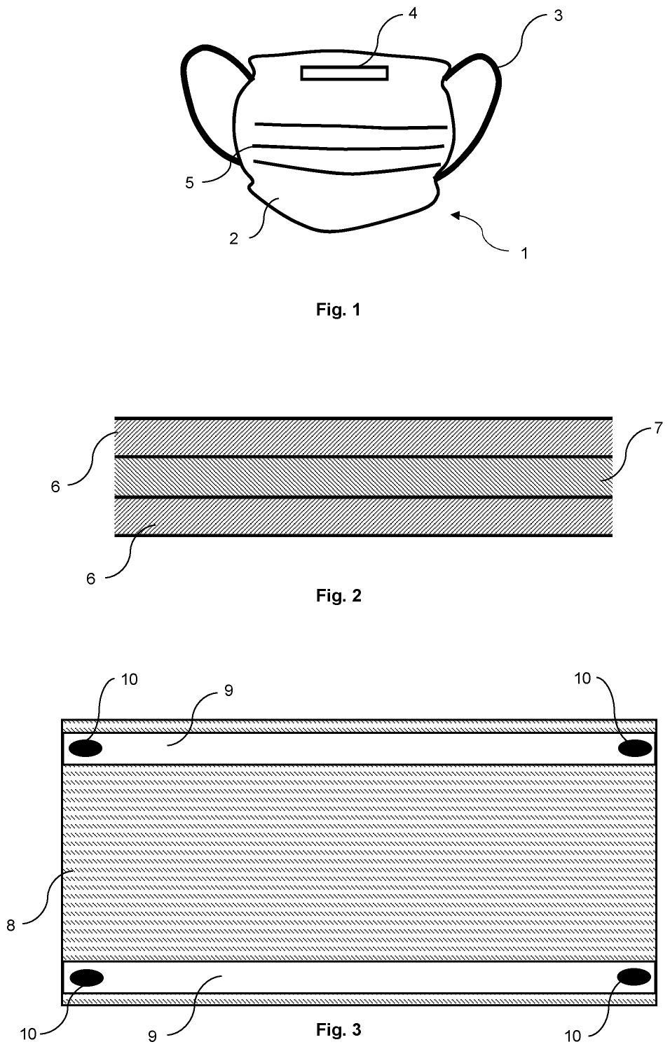

FIG. 1 schematically shows a respirator mask,

FIG. 2 shows a schematic cross-sectional view of the structure of a filter material piece of a respirator mask,

FIG. 3 shows a schematic top view of a respirator mask.

FIG. 1 shows a schematic view of a respirator mask 1 in the form of a half mask. The description refers to an example of a medical face mask. The respirator mask 1 shown comprises a filter material piece or filter part 2. The cutting shape of the filter material piece is basically rectangular, but may also take on other shapes, in particular polygonal shapes.

Two securing bands 3 are attached to the filter material piece 2 in the example shown. In the illustrated embodiment, the attachment straps are provided for attachment to the ears of the wearer.

For a better adaptation to the shape of the face, the respirator mask has a nosepiece 4 which is coupled to the filter material piece in a destructively or non-destructively detachable manner. In particular, the nosepiece may be a wire embedded in a plastic material.

A destructive connection consists of welding, for example. The welding may either be disposed continuously along the entire length of the nosepiece or at individual discrete points. Alternatively, the nosepiece may be glued to the filter material piece. For example, a hot melt may be used for this purpose, which typically also results in a destructive connection.

Alternatively, the nosepiece is provided to the user as a separate element. In this case, the nosepiece has a self-adhesive surface that is initially covered with a protective film. After removing the protective film, the user sticks the nosepiece onto the non-woven fabric. Depending on the adhesive material used, such a nosepiece may also be reused for other respiratory protection filter parts.

In the exemplary embodiment, three folds 5 are disposed in the filter part or the air-permeable material 2.

The schematic cross-sectional view of FIG. 2 shows the structure of a filter material piece for a respirator mask. A fine filter layer 7 is arranged between two support layers 6. The three layers may in particular be welded together along the edges, i.e. the circumference, of the filter part 2, as illustrated in FIG. 1.

As an alternative to the structure shown in FIG. 2, the air-permeable material of the respirator mask may also comprise fewer or more layers. For example, only one support layer and one fine filter layer may be provided.

In one embodiment, the respirator masks have one or more layers made of rPET or rPP filaments or rPET or rPP staple fibres. Regarding the individual filter layers:

Spunbonded non-woven layers made of rPET or rPP with a weight per unit area of 5 to 50 g/m² and a titre of 1 to 15 dtex are particularly suitable as support layers 6. For example, PET waste (e.g. punching waste) and so-called bottle flakes, i.e. pieces of ground beverage bottles, are used as raw materials. To cover the different colouring of the waste, it is possible to dye the recyclate. The HELIX® (Comerio Ercole) process is particularly advantageous as a thermal bonding process for bonding the spunbonded non-woven fabric.

One or more layers of meltblown non-woven made of rPET or rPP with a weight per unit area of 5 to 30 g/m² each are used as fine filter layers 7. In addition, one or more meltblown non-woven fabric layers made of virgin PP may be present. At least this layer/these layers is/are electrostatically charged. The layers of rPET or rPP may also be electrostatically charged. In this case no metallised PET waste may be used for production. Alternatively, the meltblown filaments may also consist of bicomponent fibres in which the core is made of rPET or rPP and the shell is made of a plastic material that may be particularly well electrostatically charged (e.g. virgin PP, PC, PET).

The filaments or staple fibres may also consist of bicomponent fibres in which the core is made of rPET or rPP and the shell is made of a plastic material that may be particularly well electrostatically charged (e.g. virgin PP, PC, PET).

Specifically, the filter material piece may consist of a three-layer air-permeable material. A meltblown non-woven fabric layer with a grammage of 20 g/m² is arranged between two spun-bonded non-woven fabric layers made of rPET with a grammage of 20 g/m². The SMS thus obtained may be ultrasonically welded by a weld seam running along the edges.

The meltblown non-woven fabric may be electrostatically charged by adding additives and a water jet treatment (hydro charging), as described for example in WO 97/07272.

Alternatively, the meltblown non-woven fabric may have a grammage of 25 g/m² and may have been electrostatically charged by means of a corona treatment.

The meltblown non-woven fabric may consist of bicomponent fibres that have a core made of rPP and a shell made of virgin PP. For example, the meltblown non-woven fabric may be produced with a meltblown machine from Hills Inc., West Melbourne, Fla., USA. This allows to achieve high recycled content despite electrostatic charging.

The SMS may be creped. The Micrex/microcreper process in particular may be used for this. Merely by way of example, reference is made to WO 2007/079502. The resulting increase in surface area not only leads to a softer appearance; it also enables a better adaptation to the shape of the face and a better moisture absorption.

FIG. 3 shows a schematic top view of an air-permeable material 8 corresponding to the filter part 2 of FIG. 1. However, in comparison with FIG. 1, FIG. 3 shows the rear of the filter part, i.e. the side facing a user.

In the example shown, a securing band 9 is arranged on opposite edges of the air-permeable material 8 and extends along the entire length of the edge. The securing bands may thus run with the air-permeable material during the production of the filter part and be cut together with the material. In the example shown, the securing band and the air-permeable material are joined by means of a welding point 10 at each of the opposite end regions of each securing band 9.

For the securing band, for example, a TPU laminate consisting of a TPU film with a thickness of 20 to 100 μm and a TPU meltblown non-woven (grammage: 20 to 80 g/m²) is used, which is welded to the filter material piece. The TPU film used in each case is made of plastic material recyclate. For welding, the process disclosed in European patent applications EP 18213001.3 and EP 19180533.2 in another technical field may be used to achieve high strength.

The PP material produced according to the Vistamaxx process may have been produced by meltblown or foil casting or blown film processes and—as described for the TPU laminate—may have been laminated.

1. A respirator mask, comprising a filter material piece made of an air-permeable material and at least one securing band,
wherein the air-permeable material comprises at least one layer of a non-woven fabric comprising fibres formed from one or more recycled plastic materials, and
wherein the at least one securing band is configured to secure the respirator mask to a user's head.

2. The respirator mask according to claim 1, wherein the recycled plastic material is selected from the group consisting of recycled polyesters, recycled polyvinyl chloride (rPVC), recycled polyamides, and mixtures and combinations thereof.

3. The respirator mask according to claim 1, wherein the air-permeable material is multi-layered, wherein at least one layer of the multi-layered air-permeable material comprises or is formed from a non-woven fabric, and wherein the non-woven fabric comprises or is formed from fibres comprising or being formed from one or more recycled plastic materials.

4. The respirator mask according to claim 1, wherein the air-permeable material comprises at least one support layer and at least one fine filter layer, and
wherein at least one, several or all of the support layers or at least one, several or all of the fine filter layers are non-woven fabrics comprising or formed from one or more recycled plastic materials.

5. The respirator mask according to claim 4, wherein
a) each support layer is a spunbonded non-woven, with a grammage between 5 and 80 g/m²,
b) the air-permeable material comprises 1 to 3 support layers,
c) when at least two support layers exist, a total grammage of a sum of all support layers is 10 to 200 g/m²,
d) all support layers are formed from one or more recycled plastic materials.

6. The respirator mask according to claim 4, wherein
a) each fine filter layer is an extrusion non-woven fabric, with a grammage of 10 to 80 g/m²,
b) the air-permeable material comprises 1 to 5 fine filter layers,
c) when at least two fine filter layers exist, a total grammage of a sum of all fine filter layers is 10 to 80 g/m²,
d) at least one support layer is formed from one or more recycled plastic materials, or
e) at least one fine filter layer is electrostatically charged.

7. The respirator mask according to claim 1, wherein the air-permeable material is formed in multiple layers with a layer sequence:
a support layer, one or two fine filter layers, and a further support layer.

8. The respirator mask according to claim 1, wherein the air-permeable material comprises a meltblown layer of bicomponent fibres having a core/shell construction, the core being formed of rPP and the shell being formed of virgin PP.

9. The respirator mask according to claim 1, wherein the at least one securing band comprises a recycled plastic material or is formed from one or more recycled plastic materials.

10. The respirator mask according to claim 9, wherein the at least one securing band has a multi-layer construction, the at least one securing band comprising a layer of a film and a layer of a meltblown.

11. The respirator mask according to claim 1, wherein the securing band comprises or is formed from a thermoplastic material polymer.

12. The respirator mask according to claim 11, wherein the thermoplastic material polymer is a thermoplastic elastomer.

13. The respirator mask according to claim 1, wherein a part by weight of all recycled materials relative to a total weight of the respirator mask is at least 60%.

14. (canceled)

15. The respirator mask according to claim 2, wherein the recycled polyesters comprise recycled polyethylene terephthalate (rPET), recycled polybutylene terephthalate (rPBT), recycled polylactic acid (rPLA), recycled polyglycolide, or recycled polycaprolactone.

16. The respirator mask according to claim 2, wherein the recycled polyolefins comprise recycled polypropylene (rPP), recycled polyethylene, or recycled polystyrene (rPS).

17. The respirator mask according to claim 2, wherein the air-permeable material is multi-layered, wherein at least one layer of the multi-layered air-permeable material comprises or is formed from a non-woven fabric, and wherein the non-woven fabric comprises or is formed from fibres comprising or being formed from one or more recycled plastic materials.

18. The respirator mask according to claim 2, wherein the air-permeable material comprises at least one support layer and at least one fine filter layer, and wherein at least one, several or all of the support layers or at least one, several or all of the fine filter layers are non-woven fabrics comprising or formed from one or more recycled plastic materials.

19. The respirator mask according to claim 3, wherein the air-permeable material comprises at least one support layer and at least one fine filter layer, and wherein at least one, several or all of the support layers or at least one, several or all of the fine filter layers are non-woven fabrics comprising or formed from one or more recycled plastic materials.

20. The respirator mask according to claim 4, wherein
a) each support layer is a spunbonded non-woven with a titre of fibres forming the spunbonded non-woven in the range of 0.5 to 15 dtex,
b) the air-permeable material comprises 1 to 3 support layers,
c) when at least two support layers exist, a total grammage of a sum of all support layers is 10 to 200 g/m², or
d) all support layers are formed from one or more recycled plastic materials.

21. The respirator mask according to claim 5, wherein
a) each fine filter layer is an extrusion non-woven fabric, with a grammage of 10 to 80 g/m²,
b) the air-permeable material comprises 1 to 5 fine filter layers,
c) when at least two fine filter layers exist, a total grammage of a sum of all fine filter layers is 10 to 80 g/m²,
d) at least one support layer is formed from one or more recycled plastic materials, or
e) at least one fine filter layer is electrostatically charged.
